(19) United States
(12) Patent Application Publication
(10) Pub. No.: US 2010/0158641 A1
(43) Pub. Date: Jun. 24, 2010

(54) Manipulator System

(75) Inventor: Michael J. Harper, Red Wing, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: DELAWARE CAPITAL FORMATION, INC., Wilmington, DE (US)

(21) Appl. No.: 12/640,222

(22) Filed: Dec. 17, 2009

Related U.S. Application Data
(60) Provisional application No. 61/139,339, filed on Dec. 19, 2008.

(51) Int. Cl. B25J 3/00; B25J 3/04

(52) U.S. Cl. 414/1

(57) ABSTRACT

A manipulator system having a slave tong with an input, a master handle having two outputs, and a planetary gear assembly having a sun gear, a planet gear, and a ring gear and is configured to receive the two outputs of the master handle and provide a single input to the slave tong.

This application is a non-provisional application claiming priority to U.S. Provisional Application No. 61/139,339, filed Dec. 19, 2008, and the entire contents of the U.S. Provisional Application are incorporated herein by reference.

### FIELD OF THE INVENTION

The technology disclosed herein relates generally to a manipulator system and more particularly to a telemanipulator system.

### BACKGROUND

In various industries it is preferable to work, test, assemble, and the like, in an environment that is isolated from normal ambient conditions. For example, in some medical and pharmaceutical applications, it may be preferable for such activities to occur in a substantially cleaner environment, where outside debris and bacteria cannot substantially affect conditions in the clean environment. In another example, it can be preferable for activities to be contained in a substantially dirtier environment, such as hot cells or laboratories, so inside waste does not substantially affect conditions on the outside. It is often necessary to have the capacity to manipulate devices, components, and the like, inside the isolated environment from the outside of the isolated environment without breaching the isolation of the environment itself. In various instances telemanipulators are used to conduct such activities.

Telemanipulators generally have a master arm that is mechanically, electrically, or hydraulically, or by using combinations of the three, connected to a slave arm. The slave arm is positioned on the inside of the isolated environment and the master arm is positioned outside of the isolated environment. An operator elicits and directs motion of the slave arm by maneuvering the master arm, and in many instances can perform quite complex tasks through the use of such a device. Telemanipulators can be fairly intricate devices that have numerous components and require a lot of time and expertise to assemble. It is frequently desirable to reduce the number or the complexity of components and reduce assembly time. In addition, depending on the needs of the operator, a robust telemanipulator can be desirable in a variety of applications.

### SUMMARY OF THE INVENTION

Described herein is a gas-tight telemanipulator that is capable of remotely handling objects normally found in a hot cell environment. The telemanipulator broadly has a master arm that provides an input to a slave tong. Mechanical communication chains between the master arm and slave tong enable directive motion and directive input from the master arm to elicit responsive motion of the slave tong by the slave arm.

In some embodiments, a planetary gear system merges two mechanical communication chains from the master arm to result in a single mechanical communication chain leading to the slave tong. In other words, the master handle provides a first input and a second input into a planetary gear system that has one output. Such output is received by the tong to direct the motion of the tong. One of the inputs can be directive motion from the master arm, such as physical movement of the master arm that elicits responsive motion in the slave arm and, therefore, the slave tong. Another input can be directive input from the master arm, such as buttons, toggles, switches, and the like, which electrically engage a motor that mechanically elicits responsive motion in the slave arm and so, therefore, the slave tong.

The planetary gear system incorporates a sun gear, at least one planetary gear, and a ring gear. In a first embodiment of the technology disclosed herein, a manipulator system comprises a slave tong having an input and a planetary gear assembly having a first output, a first input, and a second input. The first output of the planetary gear system is in mechanical communication with the slave tong, and the first input and second input are in mechanical communication with the first output of the planetary gear system. A master handle is in communication with the first input and the second input of the planetary gear assembly.

### BRIEF DESCRIPTION OF THE DRAWINGS

The invention may be more completely understood and appreciated in consideration of the following detailed description of various embodiments of the invention in connection with the accompanying drawings.

FIG. 1 is an example telemanipulator.

FIG. 2 is an exploded perspective view of a planetary gear assembly, consistent with the technology disclosed herein.

FIG. 3 is a partially assembled perspective view of the planetary gear assembly, consistent with the technology disclosed herein.

FIG. 4 is an assembled perspective view of the planetary gear assembly, consistent with the technology disclosed herein.

### DETAILED DESCRIPTION

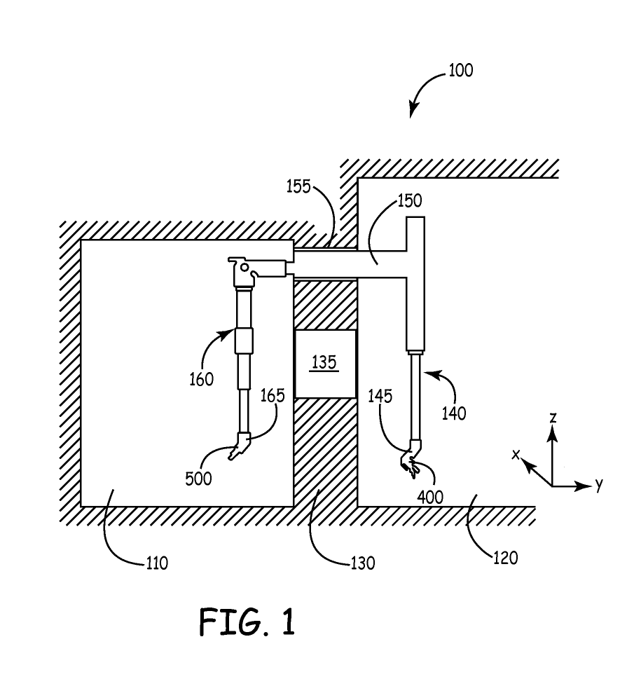

FIG. 1 is an example telemanipulator. Such a telemanipulator 100 is consistent with the technology disclosed throughout this application in various embodiments. The telemanipulator 100 broadly has three main components: a master arm 140, a slave arm 160, and a seal tube 150 that connects the master arm 140 to the slave arm 160. The slave arm 160 is in an isolated environment 110 for the purpose of manipulating content in the isolated environment 110. The master arm 140 is outside of the isolated environment 110, more specifically in a secondary environment 120 that is generally accessible to a user. The isolated environment 110 and the secondary environment 120 are separated by a wall 130 through which the seal tube 150 passes to connect the slave arm 160 to the master arm 140. The wall 130 defines a window 135 through which components in the isolated environment 110 can be viewed from the secondary environment 120.

The isolated environment 110 is, in a variety of embodiments, sealed off from the secondary environment 120 so that gases, debris, and the like cannot pass from one environment to the other, including around the seal tube 150 and the window 135. The isolated environment 110 can be a hot cell, for example.

The manipulator 100 is configured so that when the master arm 140 is maneuvered in a particular manner (“directive motion”) in the secondary environment 120, the slave arm 160 substantially responds with corresponding movements (“responsive motion”) in the isolated environment 110. The master arm 140 can be directed at least in the x-axis, y-axis, z-axis, or z-axis azimuth directions.

The master arm 140 has a master wrist joint 145 and a master handle 400 by which to further facilitate directive motions. The master arm 140 can incorporate a variety of triggers, buttons, switches, and the like for any number of commands that serve as directive input. Such triggers, buttons, switches, and the like can be disposed on the master handle 400. In one embodiment the master handle 400 incorporates a trigger that, when engaged, produces a grasping responsive motion in the slave arm 160. The master wrist joint 145 is positioned between the master handle 400 and the distal end of the master arm 140, and enables complex directive motions such as a rotational motion about an axis defined by the master wrist joint 145 and a pivot of the master handle 400 about the master wrist joint 145. In various embodiments the pivot of the master handle 400 about the master wrist joint 145 resembles a slight lift of the master handle 400 relative to the master arm 140. The dual motions enabled by the master wrist joint 145 are collectively hereinafter referred to as the “elevation and twist” motion for purposes of this application.

The responsive motion of the slave arm 160 is likewise at least in the x-axis, y-axis, z-axis, or z-axis azimuth directions. The slave arm 160 additionally has a slave tong 500 and a slave wrist joint 165 by which to facilitate responsive motions relative to the directive motions and directive inputs of the master arm 140. The slave wrist joint 165 is positioned between the distal end of the slave arm 160 and the slave tong 500, which enables rotational motion of the slave tong 500 about an axis defined by the slave wrist joint 165 and a pivot of the slave tong 500 about the slave wrist joint 165. Like mentioned above with regard to the master handle 400, the pivot of the slave tong 500 about the slave wrist joint 165 resembles a slight lift of the slave tong 500 relative to the slave arm 160. Again, these dual motions enabled by the slave wrist joint 165 are also collectively hereinafter referred to as the “elevation and twist” motion for purposes of this application.

In various embodiments the mechanical communication between the trigger on the master handle 400 and the slave tong 500 can incorporate one or more multipliers such as those used in the Model R Telemunipulator produced by Central Research Laboratories based in Red Wing, Minn. The one or more multipliers can be used to relatively increase the resulting grasping force in the slave tong 500 in response to squeezing the trigger of the master handle 400.

In various embodiments, the slave arm 160 is an independent remotely-removable unit that is interchangeable and couples with the seal tube 150 without breaking the seal between the isolated environment 110 and the secondary environment 120. In such an embodiment the slave arm 160 can contain a self-aligning, self-locking mechanism for remotely coupling or uncoupling the slave arm 160 to or from the seal tube assembly 150 from outside of the isolated environment 110. The slave tong 500 can also be remotely removable and interchangeable with other slave tongs.

The slave wrist joint 165 and the master wrist joint 145 are generally constructed so as to allow the elevation and twist motion as described above which is attainable through a variety of means known in the art. In various embodiments the wrist joint incorporates two gears and a yoke where the elevation and twist motion is driven by a chain that passes there through.

The master arm 140 is also an independent, interchangeable, removable unit that couples with the seal tube assembly 150 without breaking the seal of the isolated environment 110. The master arm 140 incorporates X-axis, Y-axis and Z-axis motion counterbalance weights for both the master arm 140 and slave arm 160.

In at least one embodiment the master handle 400 is a mechanical pistol-type-grip device that, when a trigger is engaged, causes a responsive grasping motion of the slave tong 500. The master handle 400 includes a ratchet device capable of maintaining the grasp of the slave tong 500. The ratchet is capable of being locked in or locked out of engagement. The master handle 400 also has an adjustment screw to adjust the size of the grasp of the slave tong 500 for handling objects of various widths. In multiple embodiments it can be desirable to adjust the size of the slave tong 500 grasp so that it is proportional to the grip sensation of a user operating the master handle.

The seal tube 150 is a sealed unit capable of transmitting directive motion while keeping the isolated environment 110 isolated. In one embodiment the seal tube 150 has five rotating stainless steel shafts to transmit directive motions and one rotating stainless steel shaft to actuate a slave engagement mechanism. Mounted on the master end of the seal tube 150 is a split seal plate which contains a pair of nitrile rubber spring-loaded lip seals for each shaft. The space in between each pair of seals is filled with grease.

In at least one embodiment the seal tube 150 seals off the isolated environment through a wall tube 155 that sealably extends through at least a portion of the wall 130 from the secondary environment 120 to the isolated environment 110. The seal tube 150 is sealably disposed within the wall tube 155 with at least two nitrile rubber spring-loaded lip seals sealed to the end of the wall tube 155 towards secondary environment 120. The space between the lip seals is generally filled with grease. Such a configuration allows the seal tube 150 to rotate within the wall tube 155 while maintaining the sealed isolated environment 110. The seal tube 150 can be configured to engage a variety of master arms and slave arms that can vary to fit the needs of particular applications.

In one embodiment the seal tube 150 is flange mounted, sealing to the secondary environment 120 side of the wall 130. In one embodiment the flange is 14 inches (356 mm) in diameter with eight equally-spaced 0.51 inch (13.1 mm) diameter holes on a 12.728 inch (323.3 mm) diameter bolt circle. Pairs of opposite holes are on a horizontal line through the wall tube 155 center. There also is a contamination barrier between the seal tube 150 and the wall tube 155, located on the slave end of the seal tube 150. Such a contamination barrier can be consistent with those known in the art.

In another embodiment, the seal tube 150 mounts and seals to the inside diameter of the wall tube 155 near the secondary-environment-side of the wall tube 155. As one example, the wall tube 155 has an inside diameter of 10.02 inches (254.5 mm). The seal consists of a pair of neoprene rings which are compressed axially and expand to seal the seal tube 150 assembly to the inside diameter of the wall tube 155.

The manipulator 100 additionally has electrically-driven indexing in the X, Y and Z directions that is accessed through manually operated switches on the master arm 145 side that provide directive input by engaging a motor which can be an electrical motor. The X-axis motion is defined by rotation of the slave arm 160 parallel with the X-axis. In one embodiment the slave arm 160 can be indexed up to 30° in either X-axis direction relative to the master arm 140. In one embodiment the motor is capable of indexing the slave arm at a rate of 1.2° per second. The Y-axis motion is defined by rotation of the slave arm 160 parallel with the Y-axis. In one embodiment the slave arm 160 is capable of being indexed from 90° to −15° relative to the slave arm 160 position perpendicular to the plane defined by the X-axis and the Y-axis, where a positive angle is defined as movement away from the wall 130. In this embodiment the motor is capable of indexing the slave arm at about a rate of 5° per second. The Z-axis motion is defined by linear motion along the Z-axis. In one embodiment, the motor is capable of lifting 60 pounds (50 kg) at a rate of 1.2 inches (30 mm) per second.

Responsive motion in the slave tong 500 is initiated through a mechanical communication chain that is in communication with the master handle 400 and transmits the directive motion to the slave tong 500. Directive inputs, as described above, can be disposed on the master arm 140, but are generally accessible from the master handle 400 and thus are referred to as being inputted from the master handle 400 for purposes of this application. Furthermore, for purposes of this application, the combination of elements that contribute to the responsive motion of the slave tong 500 in response to directive motions and inputs of the master handle 400 are referred to as a mechanical communication chain. In various embodiments the mechanical communication chain is a substantially mechanical system that can incorporate electronic elements. In at least one embodiment the mechanical communication chain is a substantially electronic system that incorporates mechanical elements. Such mechanical communication chain begins from a directive motion or directive input at the master handle 400 and eventually leads to responsive motion of the slave tong 500.

The mechanical communication chain comprises a variety of gears, pulleys, chains, cables, drums, motors, and the like that are configured to receive directive motions and directive inputs of the master handle 400 and elicit responsive motion of the slave tong 500.

Generally each axis of motion has a particular mechanical communication chain associated with it. A first mechanical communication chain is configured to direct the slave tong along a first axis in response to a directive motion of the master arm. Such first axis can be the X-axis in multiple embodiments. Additionally, a second mechanical communication chain is further configured to direct the slave tong along a second axis in response to the directive motion of the master arm. In various embodiments the second axis is the Y-axis. A third mechanical communication chain is configured to direct the slave tong along a third axis in response to the directive motion of the master arm, which can be the Z-axis. A fourth mechanical communication chain is configured to direct the slave tong about the third axis in response to the directive of the master arm, which can correspond to the Z-axis azimuth responsive motion.

The movement associated with the electrically-driven indexing in the X, Y and Z directions is accessed through manually operated switches from the master handle 400 that provide directive input by engaging a motor. In various embodiments the motor is an electrical motor. The motor is a component in at least one mechanical communication chain to elicit responsive motion of the slave tong 500 from the directive input of at least one switch, toggle, trigger, or the like, of the master handle 400. The mechanical communication chains associated with electrically-driven indexing of the X, Y and Z axis can be discrete from the mechanical communication chains associated with directive motion of the master handle 400, explained in the above paragraph, or they can share one or more components, as described in the paragraph below.

For example, in a particular embodiment, a planetary gear assembly is a component in two mechanical communication chains eliciting responsive motion of the slave tong 500 along a particular axis. The first mechanical communication chain is one eliciting responsive motion of the slave tong 500 along the particular axis based on directive motion of the master handle 400, and the second mechanical communication chain is one eliciting responsive motion of the slave tong 500 along the particular axis based on directive input of the master handle 400, such as through electrical indexing.

The planetary gear system has a first input that is in communication with directive motion of the master handle 400 and a second input that is in communication with the directive input of the master handle 400 such as switches, toggles, and the like, disposed proximate to the master handle 400 that initiates electrical indexing. In such an example, the first input of the planetary gear assembly is in mechanical communication with the master handle 400, and the second input of the planetary gear assembly is in at least partial mechanical communication with the master handle 400, such as through an electrical motor. Both the first input and the second input of the planetary gear system are in mechanical communication with a first output of the planetary gear system. The output leads to a mechanical communication chain that is configured to direct the slave tong 500 along a particular axis. In other words, the mechanical communication chain that is configured to direct the slave tong 500 based on directive motion merges at the planetary gear assembly with the mechanical communication chain configured to direct the slave tong 500 based on directive input. Both such mechanical communication chains are configured to direct the slave tong 500 along the same axis.

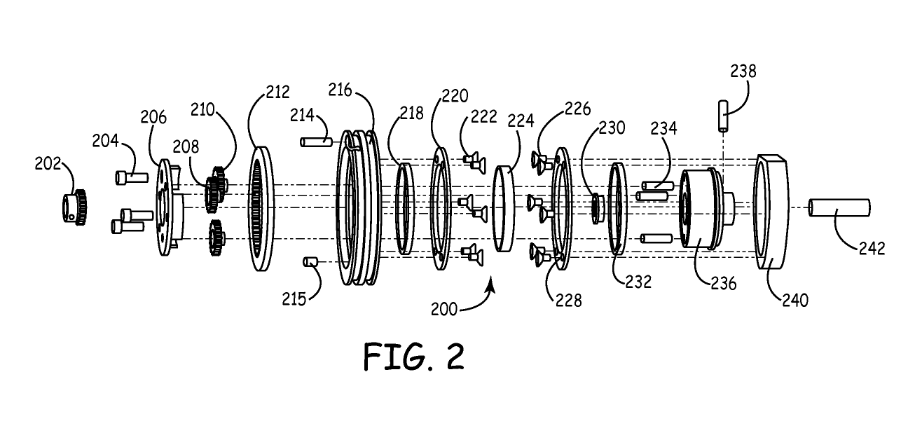

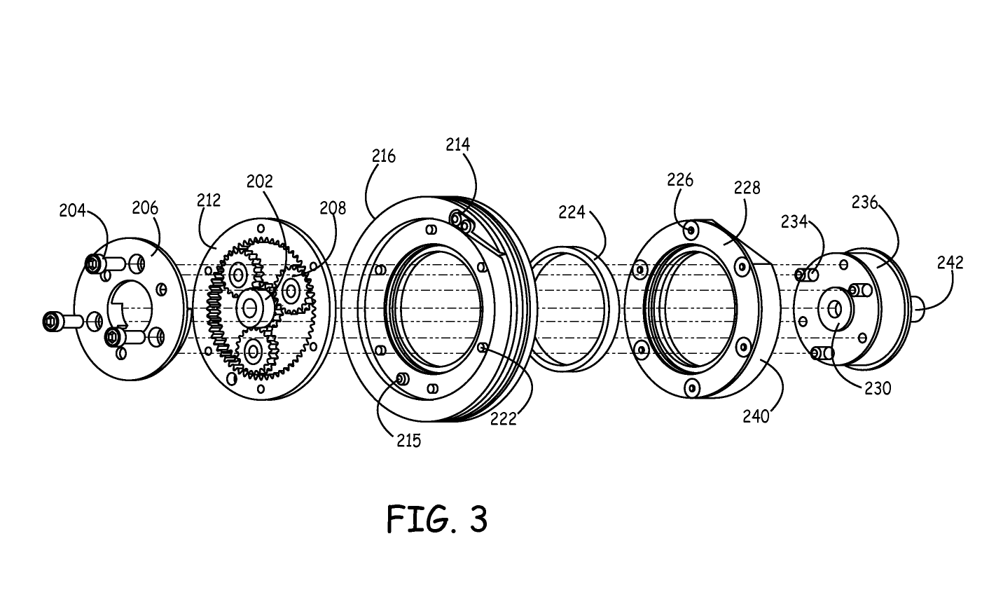

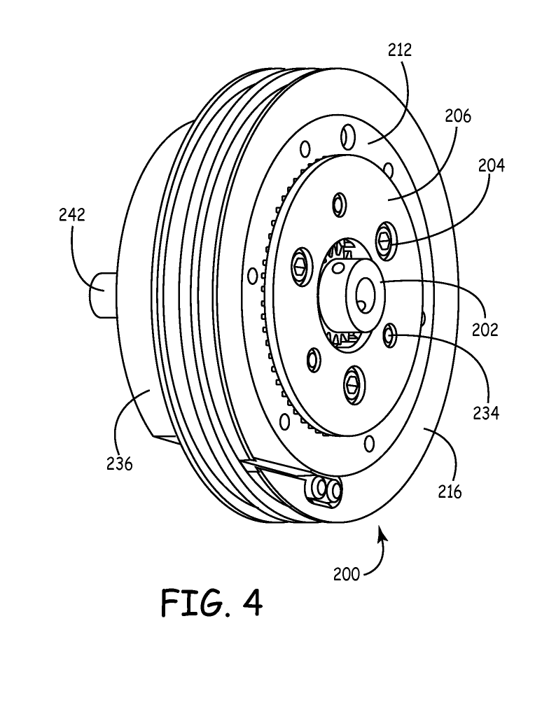

Planetary gear assembly as used herein means at least a sun gear and a planet gear that rotates around the sun gear where the sun gear and planet gear mutually engage. In some embodiments, a planetary gear assembly includes at least a sun gear, a planet gear configured to engage the sun gear, and a ring gear disposed around the sun gear and the planet gear that is configured to engage the planet gear. In some embodiments, planetary gear assembly includes at least a sun gear, one or more planetary gears that engage the sun gear, and a ring gear that engages the planetary gears. A planetary gear system that includes the planetary gear assembly, consistent with the present application, is described in more detail in the description of FIG. 2, FIG. 3, and FIG. 4, below.

FIG. 2 and FIG. 3 are an exploded perspective view and a partially assembled perspective view, respectively, of a planetary gear system, consistent with the technology disclosed herein. A first set of screws 204 (socket head cap screws, for example) are received by a cover plate 206 and are designed to engage a hub carrier 236. A sun gear 202, three planet gears 210, and a ring gear 212 are configured to mutually engage as depicted in FIG. 3. An annular tape drum 216 defines a surface that is configured to receive the ring spur gear 212. Two first drum dowel pins 214 and one short dowel pin 215 is configured also received by the annular tape drum 216. The two first drum dowel pins 214 are configured to frictionally engage tape that is disposed around the perimeter of the tape drum. The short dowel pin 215 receives the ring gear 212 to create structural alignment of the assembly.

Three planet gear dowel pins 234 are received by gear bearings 208 of each planet gear 210 and the hub carrier 236. First plate screws 222 couple a first bearing plate 220 to the tape drum 216 and second plate screws 226 couple a second bearing plate 228 to a bearing mount 240. The first bearing plate 220 and the second bearing plate 228 secure the outer race of a first bearing 218 and the outer race of a second bearing 232, respectively. A bearing spacer 224 is disposed between the inner race of the first bearing 218 and inner race of the second bearing 232. The hub carrier 236 receives a bearing 230 and a drive shaft 242. Both the hub carrier 236 and the drive shaft 242 receive a hub dowel pin 238.

In various embodiments other means of coupling various components of the planetary gear system 200 can be used and are generally known in the art. In the embodiment depicted in FIG. 2 and FIG. 3, the first set of screws 204 are socket head cap screws in one embodiment and are constructed from stainless steel. Additionally, the first plate screws 222 and second plate screws 226 are stainless steel flat head counter-sunk screws. Additionally, components are constructed of materials generally used in the art. In this particular embodiment, the cover plate 206, tape drum 216, bearing spacer 224, first bearing plate 220, second bearing plate 228, hub carrier 236 and bearing mount 240 are constructed of aluminum. The drive shaft 242, bearing 230, planet spur gears 210, ring spur gear 212, and output spur gear are constructed of one or more types stainless steel. The planet spur gears 210, ring spur gear 212 and output spur gear can be constructed of a high-strength stainless steel such as 17-4 stainless steel. Other types of materials are also anticipated.

FIG. 4 is a perspective view of the fully assembled planetary gear system depicted in FIG. 2 and FIG. 3 and can be fully understood in view of those figures. There are generally two inputs to the planetary gear system 200. A first mechanical communication chain is coupled to the first input, and a second mechanical communication chain is coupled to the second input. The first input is through the drive shaft 242. The drive shaft 242 in the embodiment described is configured to be in mechanical communication with the output of a motor for electrical indexing as described in the discussion of FIG. 1. The drive shaft is coupled to the input of planetary gear assembly which is, in this embodiment, the planetary gears. The second way to provide input to the planetary gear system is through the tape drum 216 that is configured to receive tape that frictionally engages the tape drum 216. The tape drum 216 is coupled to the second input of the planetary gear assembly, specifically the ring gear in this embodiment. Through both methods of input into the planetary gear assembly, speed of the motion is translated to force of motion and results in an output through the sun gear 202. The sun gear 202 is coupled to another mechanical communication chain. In at least one embodiment, the sun gear 202 coupled to the mechanical communication chain that results in responsive motion along the Z-axis.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

We claim:

1. A manipulator system comprising:
a slave tong having an input;
a planetary gear assembly having a first output, a first input, and a second input, wherein the first output is in mechanical communication with the slave tong, and the first input and second input are in mechanical communication with the first output; and
a master arm in communication with the first input and the second input of the planetary gear assembly.

2. The manipulator system of claim 1 wherein the master arm is in mechanical communication with the first input of the planetary gear assembly.

3. The manipulator system of claim 1 wherein the master arm is in at least partial electrical communication with the second input of the planetary gear assembly.

4. The manipulator system of claim 3 wherein the master arm is in electrical communication with a motor and the motor is in mechanical communication with the slave tong.

5. The manipulator system of claim 1 wherein the planetary gear assembly comprises at least a sun gear, at least one planet gear configured to engage the sun gear, and a ring gear configured to engage the at least one planet gear.

6. The manipulator system of claim 5 wherein the ring gear is the first input.

7. The manipulator system of claim 5 wherein the sun gear is the first output.

8. The manipulator system of claim 5 wherein the at least one planet gear is the second input.

9. The manipulator system of claim 1 comprising three planetary gears.

10. A manipulator system comprising:
a slave tong;
a master handle in communication with the slave tong;
a first mechanical communication chain responsive to directive motion of the master handle;
a second mechanical communication chain responsive to directive input of the master handle;
a planetary gear assembly having a first input, a second input, and a first output, wherein the first mechanical communication chain is coupled to the first input, and the second mechanical communication chain is coupled to the second input; and
a third mechanical communication chain responsive to the first output of the planetary gear assembly, configured to elicit responsive motion of a slave tong.

11. The manipulator system of claim 10 wherein the planetary gear assembly comprises at least a sun gear, at least one planet gear configured to engage the sun gear, and a ring gear configured to engage the at least one planet gear.

12. The manipulator system of claim 11 wherein the ring gear is the first input.

13. The manipulator system of claim 11 wherein the sun gear is the first output.

14. The manipulator system of claim 11 wherein the at least one planet gear is the second input.

15. The manipulator system of claim 10 wherein the second mechanical communication chain comprises a motor in electrical communication with the master handle, where the motor is in mechanical communication with the slave tong.

16. The manipulator system of claim 10 comprising three planetary gears.
